(19) United States
(12) Patent Application Publication
(10) Pub. No.: US 2010/0165663 A1
(43) Pub. Date: Jul. 1, 2010

(54) Optical plate and backlight module using the same

(75) Inventor: Shao-Han Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Hon Hai Precision Industry Co., LTD

(21) Appl. No.: 12/319,042

(22) Filed: Dec. 31, 2008

(51) Int. Cl. F21V 7/09; G02F 1/13357

(52) U.S. Cl. 362/625; 362/97.2

(57) ABSTRACT

An optical plate includes a first surface and a second surface opposite to the first surface. A plurality of elongated, arc-shaped depressions is defined in the first surface. A plurality of elongated, arc-shaped protrusions and a plurality of elongated, V-shaped protrusions protrude from the second surface. An extending direction of the elongated, arc-shaped protrusions intersects with an extending direction of the elongated, V-shaped protrusions. An extending direction of elongated, arc-shaped depressions is substantially parallel with the extending direction of the elongated, arc-shaped protrusions.

### CROSS-REFERENCE TO RELATED APPLICATIONS

This application is related to five co-pending U.S. patent applications, which are: and applications Ser. No. [to be determined], with Attorney Docket No. US21577, US21607, US21677, US21685, and US21688, and all entitled “OPTICAL PLATE AND BACKLIGHT MODULE USING THE SAME”. In the co-pending applications, the inventor is Shao-Han Chang. The co-pending applications have the same assignee as the present application. The disclosure of the above identified applications is incorporated herein by reference.

### BACKGROUND

1. Technical Field

The present disclosure relates to an optical plate and, a backlight module using the optical plate.

2. Description of the Related Art

Referring to FIG. 8, a typical direct type backlight module 100 includes a frame 11, a plurality of lamps 12 positioned above a base of the frame 11, a light diffusion plate 13, and a prism sheet 10 stacked on top of the frame 11 in that order. Inside walls of the frame 11 are configured for reflecting some of the light upwards. The light diffusion plate 13 includes a plurality of dispersion particles (not shown) therein, for scattering light to enhance the uniformity of light exiting the light diffusion plate 13.

Referring to FIG. 9, the prism sheet 10 includes a base layer 101 and a prism layer 103 formed on the base layer 101. The prism layer 103 includes a plurality of parallel prism lenses 105 having a triangular cross section. The prism lenses 105 are configured for collimating received light. Typically, a method of manufacturing the prism sheet 10 includes coating the base layer 101 with a melted ultraviolet (UV)-cured transparent resin to form V-shaped lenses, then solidifying the melted UV-cured transparent resin to form the prism lenses 105.

In use, light from the lamps 12 enters the diffusion plate 13 and becomes scattered before leaving the light diffusion plate 13 to the prism sheet 10. The scattered light then travels through the prism sheet 10 and is refracted out at the prism layer 103 of the prism lenses 105. Thus, the refracted light leaving the prism sheet 10 is concentrated at the prism layer 103 and a brightness (illumination) of the prism sheet 10 is increased. The refracted light then propagates into an LCD panel (not shown) positioned above the prism sheet 10.

However, although light from the light sources 12 enters the diffusion plate 13 and becomes scattered, strong light spots of the light sources 12 directly above the light sources 12 are often formed. Therefore, an upper diffusion film 14 may be positioned on the prism sheet 10 to reduce or eliminate light spots of the light sources 12.

Although the upper light diffusion film 14 and the prism sheet 10 are in contact with each other, a plurality of air pockets may still exist around the boundaries of the light diffusion film 14 and the prism sheet 10. When the backlight module 100 is in use, light passes through the air pockets, and some of the light undergoes total reflection by the air pockets along one or more corresponding boundaries. In addition, the upper light diffusion film 14 may absorb a certain amount of the light from the prism sheet 10. As a result, a brightness of light illumination of the backlight module 100 is reduced.

What is needed, therefore, is a new optical plate and a backlight module using the optical plate that can overcome the above-mentioned shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a cross-sectional view of one embodiment of a backlight module including a first embodiment of an optical plate.

FIG. 2 is an isometric view of the optical plate of FIG. 1.

FIG. 3 is a cross-sectional view of the optical plate of FIG. 2, taken along line III-III.

FIG. 4 is a cross-sectional view of the optical plate of FIG. 2, taken along line IV-IV.

FIG. 5 is a photo showing an illumination distribution testing light of an LED.

FIG. 6 is a photo showing an illumination distribution testing light of an LED passing through the optical plate of FIG. 2.

FIG. 7 is a cross-sectional view of a second embodiment of an optical plate.

FIG. 8 is a cross-sectional view of a typical backlight module employing a typical prism sheet.

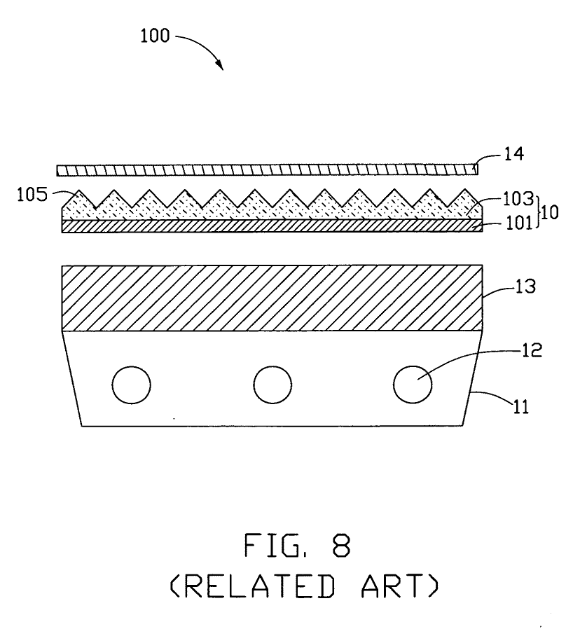

FIG. 9 is an isometric view of the typical prism sheet shown in FIG. 9.

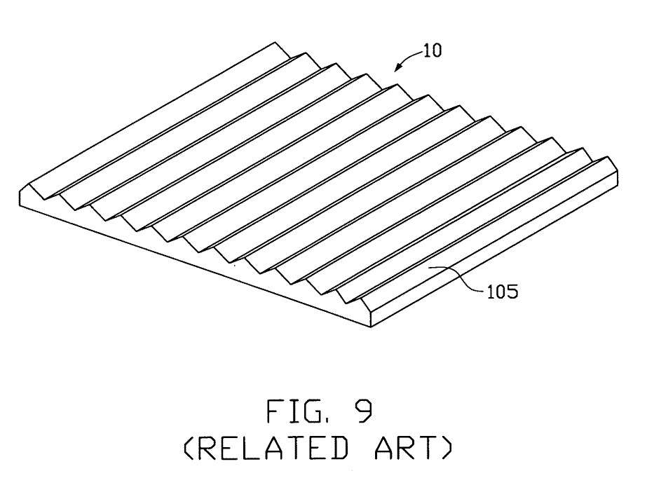

FIG. 10 is a photo showing an illumination distribution testing light of an LED passing the prism sheet in FIG. 9.

### DETAILED DESCRIPTION

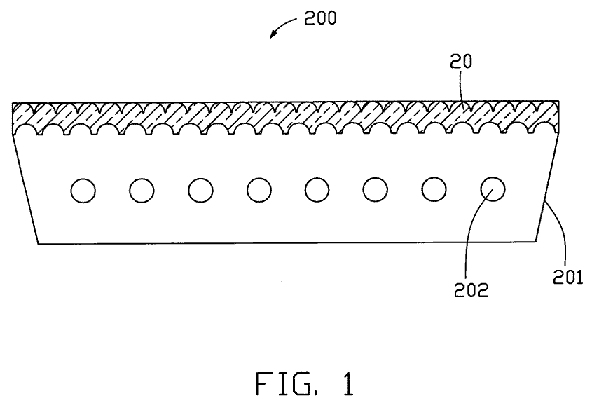

Referring to FIG. 1, one embodiment of a backlight module 200 includes an optical plate 20, a frame 201, and a plurality of lamps 202. The lamps 202 are regularly aligned above a base of the frame 201. The optical plate 20 is positioned on the top of the frame 201.

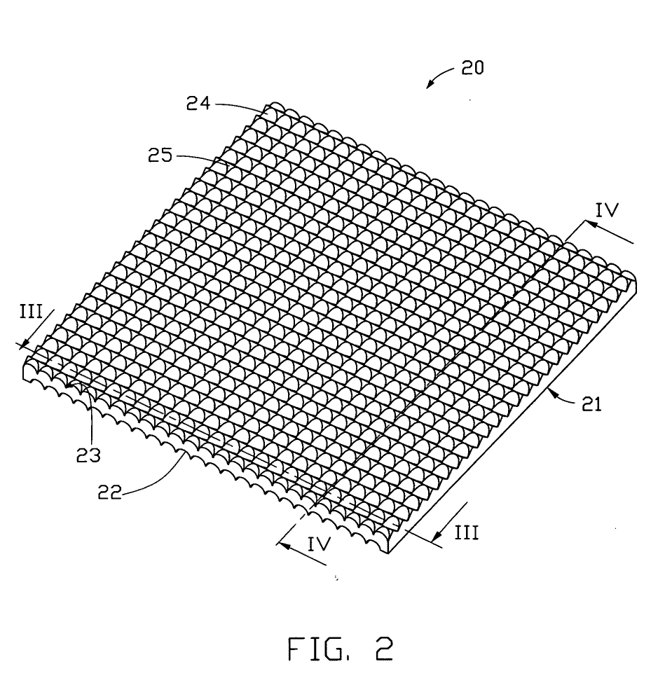

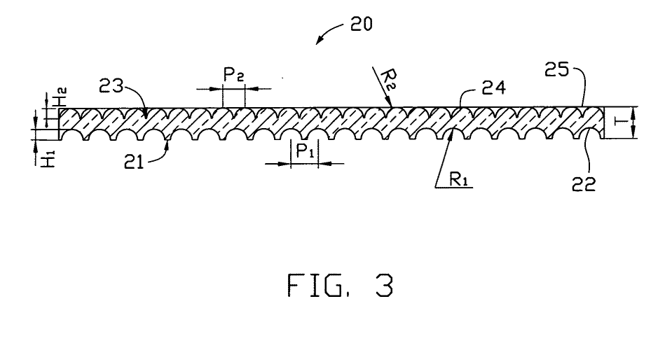

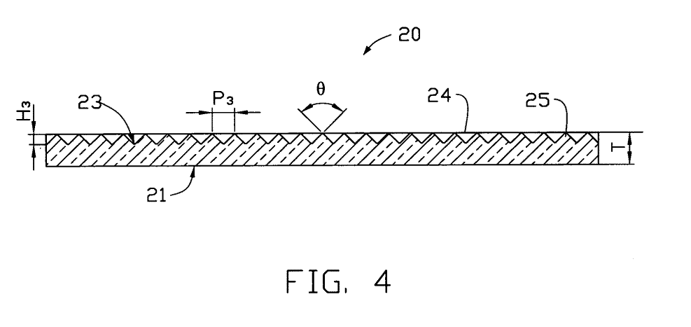

Referring to FIGS. 2 through 4, the optical plate 20 has a first surface 21 and an opposite second surface 23. The first surface 21 defines a plurality of elongated, arc-shaped depressions 22. A plurality of elongated, arc-shaped protrusions 24 and a plurality of elongated, V-shaped protrusions 25 extend from the second surface 23. An extending direction of the elongated, arc-shaped protrusions 24 may be parallel to an extending direction of the elongated, arc-shaped depressions 22. The extending direction of the elongated, arc-shaped protrusions 24 is substantially perpendicular to an extending direction of the elongated V-shaped protrusions 25. In an alternative embodiment, the elongated, arc-shaped depressions 22 and the elongated, arc-shaped protrusions 24 are both aligned obliquely relative to edges of the optical plate 20.

The elongated, arc-shaped depressions 22 are aligned side by side on the first surface 21 of the optical plate 20. Each of the elongated, arc-shaped depressions 22 may have a semi-circular cross-section taken along a direction perpendicular to the extending direction thereof. A pitch P₁ between adjacent elongated, arc-shaped depressions 22 is about 0.025 millimeters (mm) to about 1.5 mm. A radius R₁ of a circular arc defined by the semi-circular cross section taken along a direction perpendicular to the extending direction of the elongated, arc-shaped depressions 22 is equal to or larger than 0.01 mm, and less than 3 mm. A depth H₁ of each elongated, arc-shaped depression 22 is equal to or larger than 0.01 mm, and less than 3 mm.

The elongated, arc-shaped protrusions 24 are aligned side by side on the second surface 23 of the optical plate 20. Each of the elongated, arc-shaped protrusions 24 may have a semi-circular cross section taken along a direction perpendicular to the extending direction of the elongated, arc-shaped protrusions 24. A pitch P₂ between adjacent elongated, arc-shaped protrusions 24 is about 0.025 mm to about 1.5 mm. A radius R₂ of a circular arc defined by the semi-circular cross section taken along a direction perpendicular to the extending direction of the elongated, arc-shaped protrusions 24 is equal to or larger than 0.01 mm, and less than 3 mm. A height H₂ of each elongated, arc-shaped protrusion 24 is equal to or larger than 0.01 mm, and less than 3 mm. In another embodiment, adjacent elongated, arc-shaped protrusions 24 may be spaced apart from each other by a predetermined interval.

The elongated, V-shaped protrusions 25 are aligned side by side on the second surface 23 of the optical plate 20. Each of the elongated, V-shaped protrusions 25 may have a triangular cross section taken along a direction perpendicular to the extending direction of the elongated, V-shaped protrusions 25. A pitch P₃ between adjacent elongated, V-shaped protrusions 25 is about 0.025 mm to about 1 mm. A vertex angle θ of the elongated, V-shaped protrusions 25 is about 80 degrees to about 100 degrees. A height H3 of each elongated, V-shaped protrusion 25 is equal to or larger than 0.01 mm, and less than 3 mm.

A thickness T of the optical plate 20 is about 0.5 mm to about 3 mm. The optical plate 20 can be made of transparent material such as polycarbonate (PC), polymethyl methacrylate (PMMA), polystyrene (PS), copolymer of methylmethacrylate and styrene (MS), and any suitable combination thereof.

Referring to FIG. 1 again, the lamps 202 may be point light sources such as light emitting diodes or linear light sources such as cold cathode fluorescent lamps. In the illustrated embodiment, the lamps 202 are cold cathode fluorescent lamps. The interior of the frame 201 may be highly reflective.

The optical plate 20 is positioned on the frame 201 such that first surface 21 is adjacent to the lamps 202, and an extending direction of the lamps 202 may be substantially parallel to the extending direction of the elongated, arc-shaped protrusions 24. Light enters the optical plate 20 via the first surface 21. Since the inner surfaces of the elongated, arc-shaped depressions 22 are arced and the outer surface of the elongated, arc-shaped protrusions 24 and the elongated, V-shaped protrusions 25 are slanted, incident light that may have been internally reflected on a flat surface, are refracted, reflected, and diffracted. As a result, light outputted from the second surface 23 is more uniform than light outputted from a light output surface of a typical prism sheet. Since strong light spots of the light sources seldom occur, an extra upper light diffusion film on the optical plate 20 is unnecessary. Thus, the efficiency of light utilization is enhanced.

Referring to the Table 1 below, test samples are provided.

TABLE 1

| Test samples | Condition |
|---|---|
| 1 | LED |
| 2 | LED + prism sheet 10 |
| 3 | LED + optical plate 20 |

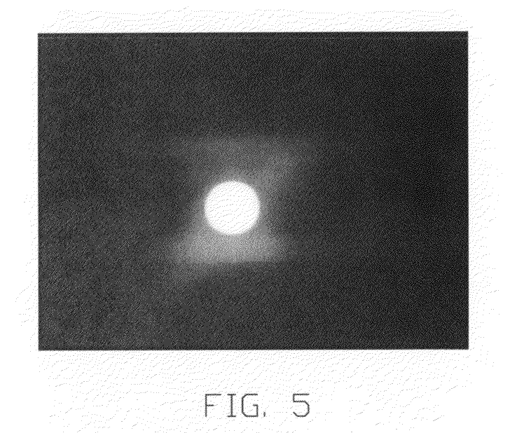

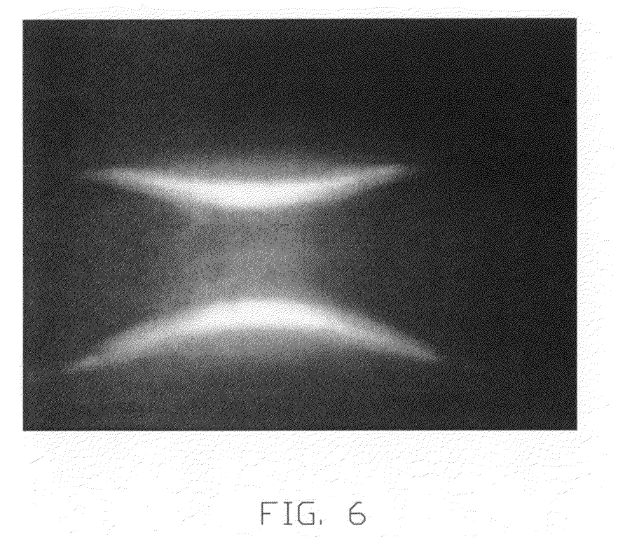

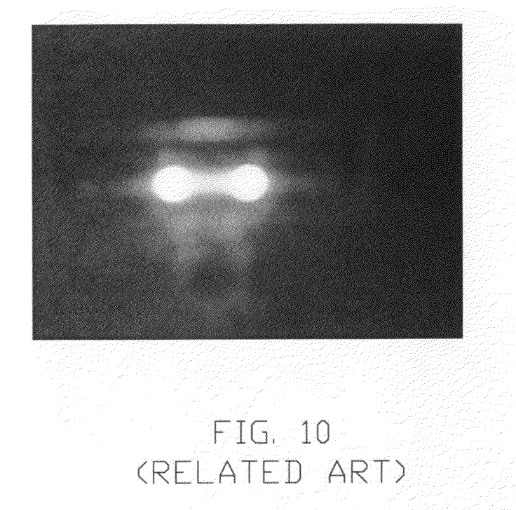

FIGS. 5, 6, and 10, reflect the test results from the test conditions in Table 1. Light spots formed on the typical prism sheet 10 are relatively strong. In contrast, light spots formed on the optical plate 20 is relatively weak. Therefore, the test results show light emitting from the optical plate 20 is more uniform.

Moreover, in contrast to the typical prism sheet 10, the optical plate 20 may be integrally formed by injection molding technology. Injection molding technology is easier to mass-produce than the typical prism sheet 10. Typical prism sheets 10 are formed by solidifying melted ultraviolet-cured transparent resin, and as such, the prism lenses are easily damaged due to poor rigidity and mechanical strength and scratched. The optical plate 20 has better rigidity and mechanical strength, and therefore, has a relatively high reliability.

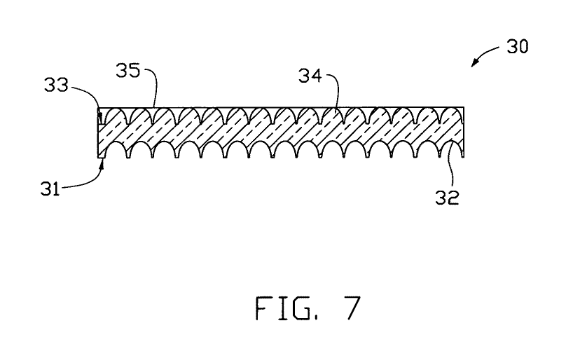

Referring to FIG. 7, a second embodiment of an optical plate 30 is similar in principle to the optical plate 20. The first surface 31 defines a plurality of elongated, arc-shaped depressions 32. A plurality of elongated, arc-shaped protrusions 34 and a plurality of elongated, V-shaped protrusions 35 protrude from the second surface 33. The elongated, arc-shaped protrusions 34 intersect with the elongated, V-shaped protrusions 35. However, each of the elongated, arc-shaped depressions 32 has a semi-elliptical cross section taken along a direction perpendicular to an extending direction thereof. Each of the elongated, arc-shaped protrusions 34 has a semi-elliptical cross section taken along a direction perpendicular to an extending direction thereof.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An optical plate, comprising:
a first surface;
a second surface opposite to the first surface;
a plurality of elongated, arc-shaped depressions defined in the first surface; and
a plurality of elongated, arc-shaped protrusions and a plurality of elongated, V-shaped protrusions extending from the second surface;
wherein an extending direction of the elongated, arc-shaped protrusions intersects with an extending direction of the elongated, V-shaped protrusions; an extending direction of elongated, arc-shaped depressions is substantially parallel to the extending direction of the elongated, arc-shaped protrusions.

2. The optical plate according to claim 1, wherein the extending direction of the elongated, arc-shaped protrusions is substantially perpendicular to the extending direction of the elongated, V-shaped protrusions.

3. The optical plate according to claim 1, wherein each of the elongated, arc-shaped depressions has one of a semi-elliptical and a semi-circular cross section taken along a direction perpendicular to an extending direction thereof.

4. The optical plate according to claim 3, wherein a radius of a circular arc defined by the semi-circular cross section taken along a direction perpendicular to the extending direction of the elongated, arc-shaped depressions is equal to or larger than 0.01 millimeter (mm), and less than 3 mm.

5. The optical plate according to claim 1, wherein adjacent elongated, arc-shaped depressions are regularly spaced apart from each other.

6. The optical plate according to claim 1, wherein the elongated, arc-shaped depressions are aligned side by side on the first surface of the optical plate.

7. The optical plate according to claim 1, wherein a pitch between adjacent elongated, arc-shaped depressions is about 0.025 mm to about 1.5 mm.

8. The optical plate according to claim 1, wherein a depth of each elongated, arc-shaped depression is equal to or larger than 0.01 mm, and less than 3 mm.

9. The optical plate according to claim 1, wherein each of the elongated, arc-shaped protrusions has one of a semi-elliptical and a semi-circular cross section taken along a direction perpendicular to an extending direction thereof.

10. The optical plate according to claim 9, wherein a radius of a circular arc defined by the semi-circular cross section taken along a direction perpendicular to the extending direction of the elongated, arc-shaped protrusions is equal to or larger than 0.01 mm, and less than 3 mm.

11. The optical plate according to claim 1, wherein the elongated, arc-shaped protrusions are aligned side by side on the second surface of the optical plate.

12. The optical plate according to claim 1, wherein adjacent elongated, arc-shaped protrusions are regularly spaced apart from each other.

13. The optical plate according to claim 1, wherein a pitch between adjacent elongated, arc-shaped protrusions is about 0.025 mm to about 1.5 mm.

14. The optical plate according to claim 1, wherein a height of each elongated, arc-shaped protrusion is equal to or larger than 0.01 mm, and less than 3 mm.

15. The optical plate according to claim 1, wherein a vertex angle of the elongated, V-shaped protrusions is about 80 degrees to about 100 degrees.

16. The optical plate according to claim 1, wherein a pitch of adjacent elongated, V-shaped protrusions is about 0.025 mm to about 1 mm.

17. The optical plate according to claim 1, wherein each of the elongated, V-shaped protrusions has a triangular cross section taken along a direction perpendicular to the extending direction of the elongated, V-shaped protrusions

18. A backlight module, comprising:
a frame;
a plurality of lamps positioned in an inner side of the frame; and
an optical plate positioned on the frame above the lamps, comprising:
a first surface;
a second surface opposite to the first surface;
a plurality of elongated, arc-shaped depressions defined in the first surface; and
a plurality of elongated, arc-shaped protrusions and a plurality of elongated, V-shaped protrusions extending from the second surface;
wherein an extending direction of the elongated, arc-shaped protrusions intersects with an extending direction of the elongated, V-shaped protrusions; an extending direction of elongated, arc-shaped depressions is substantially parallel with the extending direction of the elongated, arc-shaped protrusions.

19. The backlight module according to claim 18, wherein the light sources are linear light sources; an extending direction of the light sources is substantially parallel to that of the elongated, arc-shaped protrusions.
